(19) United States
(12) Patent Application Publication
(10) Pub. No.: US 2013/0339075 A1
(43) Pub. Date: Dec. 19, 2013

(54) USING PAST AND SCHEDULED EVENTS TO REDUCE THE COST OF MISTAKES IN AN EDISCOVERY PROCESS MANAGEMENT SYSTEM

(71) Applicants: Roman Kisin, San Jose, CA (US); Pierre Raynaud-Richard, Redwood City, CA (US); Irina Simpson, Sunnyvale, CA (US)

(72) Inventors: Roman Kisin, San Jose, CA (US); Pierre Raynaud-Richard, Redwood City, CA (US); Irina Simpson, Sunnyvale, CA (US)

(73) Assignee: INTERNATIONAL BUSINESS MACHINES CORPORATION, Armonk, NY (US)

(21) Appl. No.: 13/517,874

(22) Filed: Jun. 14, 2012

(51) Int. Cl. G06Q 10/06

(52) U.S. Cl. 705/7.13

(57) ABSTRACT

Method, system, and computer program product for using past and scheduled events to reduce the cost of mistakes in an electronic discovery process management system. The operation includes providing an electronic discovery process management system configured to manage a plurality of legal matters; defining at least one scheduling rule associated with each legal matter; scheduling, based on the at least one scheduling rule, at least one event associated with each matter in the electronic discovery process management system, each event comprising a set of attributes including a first attribute comprising a matter related to the event and a second attribute comprising a due date of the event; and monitoring the at least one event to track the due date of the at least one event.

### BACKGROUND

Embodiments described herein relate to use of computer software which utilizes past and scheduled events to reduce the cost of mistakes in an electronic discovery process management system.

Corporate legal departments typically face a substantial volume of litigation. Discovery refers to a pre-trial phase of the litigation process where parties exchange information related to the civil action. In recent years, the proliferation of technology has allowed for the exchange of information, such as documents, electronically. The term “eDiscovery” has been adopted to refer to the electronic discovery process. The discovery process, electronic or otherwise, requires attorneys, paralegals, and support staff in legal departments to track and respond to a significant number of different matters. The discovery process was traditionally managed by individuals who maintained and updated spreadsheets and emails to track key items and events in the discovery process. This management system resulted in high overhead, poor quality, significant mistakes, and untenable risk. The adoption of eDiscovery has made these methods of management unsustainable, resulting in a number of software applications designed to automate the discovery process.

Discovery is a critical component of most civil actions. As part of the discovery process, parties to the action serve upon the opposition a discovery request, which identifies a number of items sought to be discovered. Current discovery rules permit discovery through a number of methods, including, but not limited to, requests for answers to interrogatories, requests for production of documents, requests for admissions, and depositions. For example, an employee-plaintiff in a wrongful termination lawsuit may serve a request for production of documents on an employer-defendant, seeking all documents related to the firing of the employee, which forms the basis of the employee's cause of action against the employer. Upon receiving the request, the legal department of the corporation is under an obligation to identify and preserve any documents, such as emails, related to the firing of the employee, such that they may be duplicated and returned to the employee-plaintiff. When the items requested are in digital format, eDiscovery rules apply, such that the employer-defendant must preserve the documents and provide them in a digital format. In some instances, a non-party may be served a discovery request if it possesses information relevant to the lawsuit. The number of documents subject to the discovery request may count in the hundreds, thousands, millions, or more, and may be possessed by numerous individuals in multiple different formats across any number of computers in any number of different jurisdictions.

In response to the discovery request, members of the legal department must place all documents subject to the discovery request, identified or unidentified, under a legal hold. The first step in the legal hold process is the transmission of a hold notice to all custodians who may possess the documents. The hold notice will typically indicate the relevant documents subject to the hold, and direct the custodians to preserve any document which may be relevant to the action to prevent spoliation. Spoliation is the intentional or negligent withholding, hiding, altering, or destroying of evidence relevant to a legal proceeding. If, for example, the corporation has a policy under which documents (electronic or paper) are destroyed on a periodic interval, the hold notice will direct the custodians to suspend the policy as to the documents subject to the legal hold. Although hold notices may be sent in response to discovery requests, corporations are under a preservation obligation in numerous settings. The preservation obligation generally extends to all forms of relevant information when litigation (including government audits, regulatory proceedings, etc.) is reasonably anticipated. Litigation, or any of its analogs, need not be current or pending in order to trigger the duty to preserve relevant evidence. A hold notice would be necessary in any of these situations to prevent the spoliation of evidence.

The fundamental nature of the workflows and processes that are part of the eDiscovery process makes the handling of exceptional circumstances (and process or workflow breakdown) critical to the integrity of the overall legal process within an organization. With the enormous increase in work volume brought on by eDiscovery, the simple act of monitoring a large set of matters for “abnormal” behavior has become increasingly resource intensive, burdensome, and error prone. The repetitive, constant, and systematic review of numerous dashboard, status summary, and status indicators across many workflows and processes within each legal matter is the only practical approach to reliably track down abnormal behavior (exceptions) at their source.

In today's distributed environment, this task is further complicated, as components of the legal process are distributed across multiple persons, in geographically dispersed locations, without the benefit of focused coordination. In many instances, each user multiplexes and reacts to individual crises of the day. As a result, significant mistakes are likely to occur and remain undiscovered for a long period of time. Uncoordinated action of different players, including human error from people rarely involved in a legal matter, or lack of coordination of automated action taken by the electronic discovery application itself can result in a significant amount of wasted effort in fixing improper or inappropriate actions.

### SUMMARY

Embodiments disclosed herein provide a method, system, and computer program product for using past and scheduled events to reduce the cost of mistakes in an electronic discovery process management system. The operation includes providing an electronic discovery process management system configured to manage a plurality of legal matters; defining at least one scheduling rule associated with each legal matter; scheduling, based on the at least one scheduling rule, at least one event associated with each matter in the electronic discovery process management system, each event comprising a set of attributes including a first attribute comprising a matter related to the event and a second attribute comprising a due date of the event; and monitoring the at least one event to track the due date of the at least one event.

### BRIEF DESCRIPTION OF THE DRAWINGS

So that the manner in which the above recited aspects are attained and can be understood in detail, a more particular description of embodiments of the disclosure, briefly summarized above, may be had by reference to the appended drawings.

It is to be noted, however, that the appended drawings illustrate only typical embodiments of this disclosure and are therefore not to be considered limiting of its scope, for the disclosure may admit to other equally effective embodiments.

FIG. 1 is a diagram of a system for using past and scheduled events to reduce the cost of mistakes in an electronic discovery process management system, according to one embodiment described herein.

FIG. 2 is a flow chart illustrating a method for scheduling events to reduce the cost of mistakes in an electronic discovery process management system, according to one embodiment described herein.

FIG. 3 is a flowchart illustrating a method for using past and scheduled events to reduce the cost of mistakes in an electronic discovery process management system, according to one embodiment described herein.

FIG. 4 is a flowchart illustrating a method for generating a list of events in an electronic discovery process management system, according to one embodiment described herein.

FIG. 5 illustrates an exemplary GUI screen displaying scheduled events related to a matter in an electronic discovery process management system, according to one embodiment described herein.

FIG. 6 illustrates an exemplary GUI screen displaying a list of scheduled events within an electronic discovery process management system, according to one embodiment described herein.

### DETAILED DESCRIPTION

Embodiments disclosed herein provide a method, system, and computer program product for using past and scheduled events to reduce the cost of mistakes in an electronic discovery process management system. The operation includes providing an electronic discovery process management system configured to manage a plurality of legal matters; defining at least one scheduling rule associated with each legal matter; scheduling, based on the at least one scheduling rule, at least one event associated with each matter in the electronic discovery process management system, each event comprising a set of attributes including a first attribute comprising a matter related to the event and a second attribute comprising a due date of the event; and monitoring the at least one event to track the due date of the at least one event.

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications to monitor events or related data available in the cloud. For example, an application to monitor events in an eDiscovery process management system could execute on a computing system in the cloud and monitor events to notify and alert users of critical dates. In such a case, the application could monitor event dates and times and store a list of scheduled events at a storage location in the cloud.

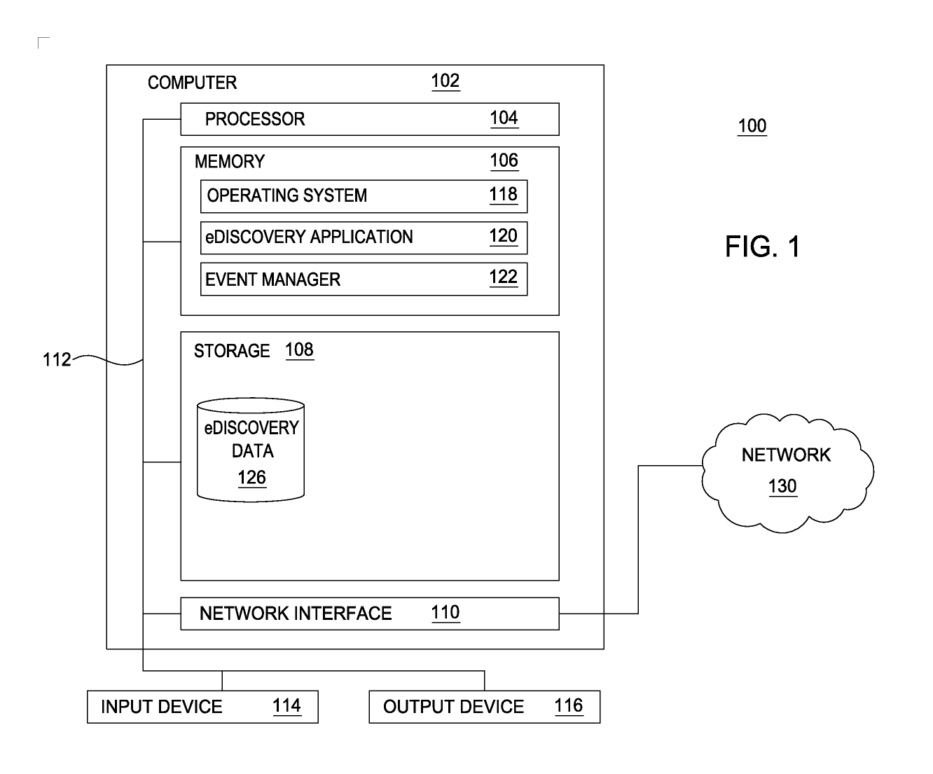

FIG. 1 is a diagram of a system 100 for using key metrics to enable efficient decision making in an electronic discovery process management system, according to one embodiment described herein. The system 100 includes a computer 102. The computer 102 may be connected to other computers via a network 130. In general, the network 130 may be a telecommunications network and/or a wide area network (WAN). In a particular embodiment, the network 130 is the Internet.

The computer 102 generally includes a processor 104 connected via a bus 112 to a memory 106, a network interface device 110, a storage 108, an input device 114, and an output device 116. The computer 102 is generally under the control of any commercially available or open source operating system 118 capable of supporting the functions disclosed herein. The processor 104 is included to be representative of a single CPU, multiple CPUs, a single CPU having multiple processing cores, and the like. Similarly, the memory 106 may be a random access memory. While the memory 106 is shown as a single entity, it should be understood that the memory 106 may comprise a plurality of modules, and that the memory 106 may exist at multiple levels, from high speed registers and caches to lower speed but larger DRAM chips. The network interface device 110 may be any type of network communications device allowing the computer 102 to communicate with other computers via the network 130.

The storage 108 may be a hard disk drive storage device. Although the storage 108 is shown as a single unit, the storage 108 may be a combination of fixed and/or removable storage devices, such as fixed disk drives, removable memory cards, optical storage, flash memory or solid state storage devices (SSD). The memory 106 and the storage 108 may be part of one virtual address space spanning multiple primary and secondary storage devices.

The input device 114 may be any device for providing input to the computer 102. For example, a keyboard, keypad, light pen, touch-screen, track-ball, or speech recognition unit, audio/video player, and the like may be used. The output device 116 may be any device for providing output to a user of the computer 102. For example, the output device 116 may be any conventional display screen or set of speakers, along with their respective interface cards, i.e., video cards and sound cards. Although shown separately from the input device 114, the output device 116 and input device 114 may be combined. For example, a display screen with an integrated touch-screen, a display with an integrated keyboard, or a speech recognition unit combined with a text speech converter may be used.

As shown, the memory 106 contains eDiscovery application 120. The eDiscovery application 120 is a general purpose eDiscovery management application used to manage all aspects of the eDiscovery process. In some embodiments, the eDiscovery application 120 provides a method to store and track information related to legal matters within an organization. In some embodiments, the eDiscovery application 120 defines workflows for each of the processes within a legal matter, provides mechanisms to issue notices and alerts related to steps in the workflow, and methods to track progress of items within the workflow. In some embodiments, the eDiscovery application 120 automates communication of discovery requirements and facts between legal staff and custodians with automatic action item assignments, notifications, alerts, work planning and views of holds and collections. One example of an eDiscovery management application is IBM® Atlas eDiscovery Process Management. (IBM is a trademark of International Business Machines Corporation, registered in many jurisdictions worldwide.)

As shown, the memory 106 also contains event manager 122. In some embodiments, the event manager 122 is an application configured to define and monitor the dates and times of events related to matters in the eDiscovery application 120. In some embodiments, the event manager 122 is a component of the eDiscovery application 120, such that the functionality of event manager 122 is performed by modules of the eDiscovery application 120. The event manager 122 provides an audit mechanism for key events in the eDiscovery application 120. In some embodiments, the event manager 122 implements a mechanism to create events and define the due dates and details of the events based on predefined scheduling rules related to the events in the eDiscovery application 120. By defining scheduling rules which apply to all legal matters in the eDiscovery application 120, the event manager 122 is able to create and schedule events related to each legal matter based on the scheduling rules such that critical dates and deadlines are not missed. In some embodiments, the scheduling rules may be explicitly defined by a user, such as a system administrator. In other embodiments, the scheduling rules may be programmatically created based on criteria provided by an application developer. For example, business rules may dictate that every legal matter in the eDiscovery application 120 must have a corresponding hold notice issued; the scheduling rules may specify that the hold notice has a due date of 10 days after creation of the legal matter. Thus, if a legal matter is created in the eDiscovery application 120 on Apr. 29, 2012, the event manager 122 may schedule an event for the hold notice having a due date of May 9, 2012. The event manager 122 may create an event entry in the eDiscovery data 126 to reflect the newly created event. Additionally, upon defining the event, the event manager 122 may also monitor the date and time of the event, and provide an indication of the due date of the event to a user of the eDiscovery application 120. As another example, a business rule may require quarterly transmission of reminder notices after the transmission of a hold notice. In such a case, the scheduling rules may allow for the programmatic calculation of a quarterly due date for the reminder notice, roughly occurring within 90 days of the last transmission. The event manager 122 may therefore schedule events with due dates occurring approximately 90 days from the transmission of the hold notice.

In some embodiments, the event manager 122 provides the ability to display the fundamental attributes of the events, including, but not limited to, a related legal matter, an event category, and an event date and time. In some embodiments, the event manager 122 provides a user interface to configure a priority level and visibility of each event, as well as for a category of events, regardless of whether the event occurred in the past or is scheduled to occur in the future. In some embodiments, the event manager 122 provides a user interface to easily visualize the different events related to one or more matters, and allows a user to navigate directly to the matter to which the event is associated. In some embodiments, the event manager 122 is configured to generate a list of events, past and future, in the eDiscovery application 120. In some embodiments, a subset of events may be selected for inclusion in the list, including, but not limited to, events related to one or more specific matters, events created by one or more specific authors, events of one or more categories, events of a specified priority level, and events whose scheduled dates fall within a specified date range. In some embodiments, the event manager 122 provides a user interface to enable a user to configure a priority level and visibility level of an event, or category of events.

In the context of the present disclosure, an event is an occurrence which takes place during the lifecycle of a legal matter being managed by the eDiscovery application 120. Further, events may have certain attributes which may include, but are not limited to, a related legal matter, an event category, event author, and an event date and time. In some embodiments, an event may also have priority and visibility attributes. The priority level provides a ranking system for each event, creating different levels of priority to reflect varying degrees of importance. The visibility is predicated on specifics of the business process. For some organizations certain events are not important and should be “filtered out.” Therefore, visibility introduces permissions to view an event, which may be restricted to particular users, groups of users, or all users. In some embodiments, the event manager 122 is configured to define, monitor, and notify users of events in the eDiscovery application 120. Events may be actual events, workflows, or activities within each matter tracked by the eDiscovery application 120. In some embodiments, the creation and due date of each event may be defined by a set of scheduling rules related to each matter in the eDiscovery application 120. For example, a scheduling rule may state that in response to the creation and transmission of a hold notice, at least one custodian receiving the notice must be added to a preservation plan within 10 days of receiving the notice. Alternatively, the events may also indicate items in the lifecycle of a legal matter whose dates are not strictly tied to scheduling rules, but the scheduling rules indicate that the event must be “scheduled” in response to the event's occurrence. For example, a legal matter may be settled early in the discovery phase, and the matter may be closed. Such an event may be scheduled and monitored by the event manager 122 such that it is displayed for any users using the eDiscovery application 120, which may allow for the processing of additional action items by the users. In such cases, the scheduling rules may state that an event must be scheduled and monitored because of the fact that the event was created within the eDiscovery application 120. Additional examples of events include, without limitation:

Matter creation—indicate when a new matter was created.

Matter closed—indicate when a matter was closed.

Matter deactivated—indicate when a matter was deactivated.

Matter reopened—indicate when a matter was reopened.

Matter access control list added—indicates when people are added to an access control list. Details may be related to specific individuals added, or a number of individuals added. An access control list is a list defining the access permissions of an object, for example an object managed by the eDiscovery application 120.

Matter access control list removed—indicates when people are removed from an access control list. Details may be related to specific individuals removed, or a number of individuals removed.

Matter action item completed—indicate that an action item is now completed, including the date completed. Action items can be created manually (e.g., attorney requests that legal assistant performs some action with optional due date) or the eDiscovery application 120 can automatically generate an action item (e.g., custodian answers interview question in a way that triggers an action item). An action item is used for tracking purposes. Attributes of an action item may include an, author, assignee, due date, status, and description of action to be performed.

Alert recipients added—indicate when and how many people were added to an alert recipients list. A list of alert recipients is maintained by the eDiscovery application 120 (or the event manager 122) to generate alerts when exceptional conditions occur. For example, alerts can be generated for people on the alert recipient list when hold notice is not delivered to a custodian.

Alert recipients removed—indicate when and how many people were removed from an alert recipients list.

Matter details modified—indicate that an attribute within the eDiscovery application 120 related to a matter were modified. May include details on which field(s) as well as past and current values for the fields.

Matter attachments added—indicate that a file was added as a matter attachment. May include details of the file, such as a file description, file name.

Document disposal approved—indicate that a disposition request has been approved.

Document disposal executed—indicate when matter documents were disposed.

Request created—indicate that a new request was created.

Request completed—indicate that a request was completed.

Request deactivated—indicate that a request was deactivated. A link to the deactivated request may be provided.

Hold notice created—indicate that a new legal hold notice draft was created.

Hold notice cloned—indicate that a new legal hold notice was created based on an existing hold notice.

Hold notice submitted for approval—indicate that a draft legal hold notice was submitted for approval.

Hold notice approved—indicate that a draft legal hold notice was approved.

Hold notice published—indicate that a legal hold notice was published.

Hold notice error—indicate that a hold notice was not approved or that publication failed.

Hold notice new recipients—indicate that new recipients were issued a legal hold notice for the first time (relative to the specific legal hold notice). A link to the legal hold notice's transmission history may be provided.

Hold notice auto-reminder sent—indicate that a legal hold notice reminder was sent. A link to the legal hold notice's transmission history may be provided, in some cases pre-filtered to identify the proper individuals.

Hold notice transmission suspended—indicate that a legal hold notice transmission was suspended.

Hold notice transmission resumed—indicate that a legal hold notice transmission was resumed.

Release notice created—indicate that a release notice draft was created. A release notice serves the function of releasing a legal hold on specified documents.

Release notice submitted for approval—indicate that a draft release notice was submitted for approval.

Release notice approved—indicate that a release notice was approved.

Release notice published—indicate that a release notice was published.

Preservation plan created—indicate that a preservation plan draft was created. A preservation plan outlines the policies and workflows implemented to fulfill a preservation obligation.

Preservation plan submitted for approval—indicate that a draft preservation plan was submitted for approval.

Preservation plan approved—indicate that a draft preservation plan was approved.

Preservation plan published—indicate that a preservation plan was published.

Preservation plan custodian list modified—indicate that the recipient list of a published preservation plan has been modified.

Preservation plan suspended—indicate submission of a request to suspend a preservation plan.

Preservation plan resumed—indicate submission of a request to resume a preservation plan.

Preservation plan released—indicate submission of a request to release a preservation plan.

Confirmation response received—indicate the total number of confirmation responses received on a given legal hold, within a specified period of time.

Custodians put on hold—indicate the total number of custodians within a preservation plan whose status has been set to “on hold” within a given time period.

Custodians past due date—indicate the total number of custodians that have not been placed on hold within the time specified by the preservation plan. This event may provide a link to the preservation plan showing a list of custodians who have not been placed on hold.

Interview plan created—indicate that a draft interview plan has been created. An interview may accompany a legal hold notice to receive responses from a custodian related to the location, quantity, and quality of documents in their custody.

Interview plan submitted for approval—indicate that a draft interview plan was submitted for approval.

Interview plan approved—indicate that a draft interview plan was approved.

Interview plan published—indicate that an interview plan was published.

Interview plan issued to new recipients—indicate that new recipients have been added to a published interview plan. May provide a link to recipient list.

Interview plan suspended—indicate that an interview plan was suspended.

Interview plan resumed—indicate that an interview plan was resumed.

Interview plan completed—indicate that an interview plan was completed.

Collection plan created—indicate that a draft collection plan (of any type, such as self collection notice plan, bulk collection plan, or structured collection plan) was created.

Collection plan submitted for approval—indicate that a draft collection plan was submitted for approval.

Collection plan approved—indicate that a draft collection plan was approved.

Collection plan published—indicate that a collection plan was published.

Collection plan issued to new recipients—indicate that new recipients or custodians have been added to a published collection plan. A link to a recipient list may be provided.

Collection plan suspended—indicate that a collection plan was suspended or requested to be suspended.

Collection plan resumed—indicate that a collection plan was resumed or requested to be resumed.

Collection plan completed—indicate that a collection plan was completed or requested to be completed.

Document exported—indicate that documents have been exported for that matter within a specified time period. May provide details on number of documents exported.

As stated above, in some embodiments, the event manager 122 may provide an interface to allow a user to set the priority level and visibility of an event, or a category of events. For example, a user may select an event, and in response, the event manager 122 will display an interface showing event attributes. From there, the event manager 122 will permit the user to modify the event visibility and priority level. For example, a user may assign the highest priority level to the “collection plan completed” event for a given matter. In some embodiments, the priority level is a range of integers, such as 1-5, or may be a category such as “low,” “medium,” and “high” priority. The visibility of an event may be set to identify specific users, groups of users, or all users who may view an event. For example, a user may set modify a visibility level from “all” users to a group of users, such as “power users.” Generally, any suitable method for setting priority and visibility levels is contemplated. Furthermore, the event manager 122 may permit a user to set all events of a category to a specific visibility and priority level, across all matters. For example, a user may assign the highest priority level to the “collection plan completed” across all matters, and specify that all users may view the event with the eDiscovery application 120 and the event manager 122.

As shown, the storage 108 contains eDiscovery data 126. The eDiscovery data 126 is data stored by the eDiscovery application 120, and includes information related to legal matters managed by the eDiscovery application 120. The types of data stored in eDiscovery data 126 include, but are not limited to, documents, legal notices, information related to the legal matter, custodian information, scheduling rules related to activities and events in each legal matter, and deadline dates. In some embodiments, the event manager 122 stores event data in the eDiscovery data 126. Examples of event data stored by the event manager 122 in the eDiscovery data 126 may include, but are not limited to, matter information, event details and attributes (as described above), event lists, and event alerts. The eDiscovery data 126, although depicted as a database in FIG. 1, may take any form sufficient to store data, and the particular storage method chosen should not be considered limiting of the disclosure.

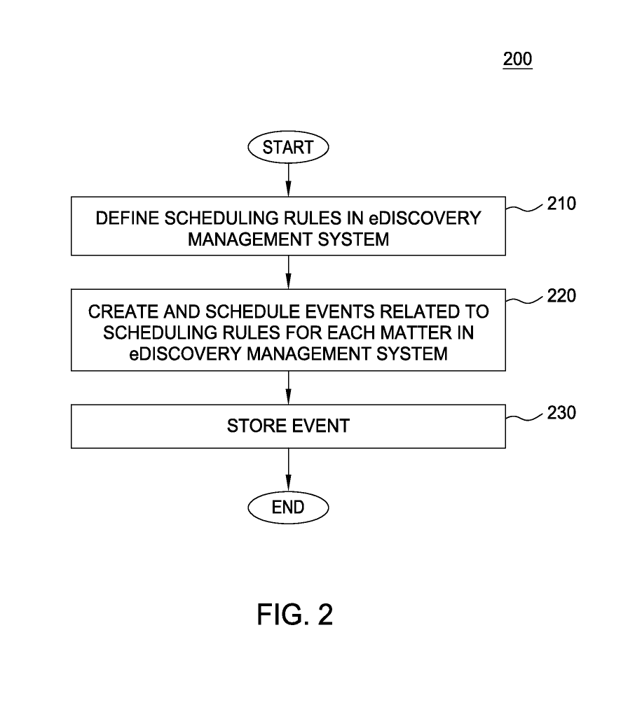

FIG. 2 is a flow chart illustrating a method 200 for scheduling events to reduce the cost of mistakes in an electronic discovery process management system, according to one embodiment described herein. Generally, the method 200 may provide a framework for the creation and scheduling of events in an electronic discovery process management system. In some embodiments, the event manager 122 performs the steps of the method 200. At step 210, scheduling rules related to legal matters within the eDiscovery application 120 are defined. A user may define the scheduling rules, or the scheduling rules may be defined by an application developer. The scheduling rules, as discussed above, may relate to any aspect of a legal matter. Scheduling rules may be nested, such that definition of one rule necessitates reference to another scheduling rule and creation of a corresponding event. For example, the creation of a legal matter has scheduling rules dictating the timing of creation, approval, transmission, and maintenance of a hold notice in each legal matter. Thus, the creation of a legal matter has a scheduling rule for a hold notice, which may in turn have additional scheduling rules regulating the lifecycle of the hold notice. As an example, a first scheduling rule may require that upon creation of a legal matter, a hold notice must be transmitted within 30 days. A second scheduling rule may require that reminder notices must be sent every 60 days after the transmission of the legal matter. The event manager 122, may create and schedule events with appropriate due dates based on these scheduling rules at step 220. For example, the event manager 122 may identify that a 90-day hold notice was published on Jan. 1, 2012, and will automatically create an associated event for the expiration of the hold notice, 90 days after publication of the hold notice. The event manager 122, based on the scheduling rules and other data, may also define the attributes of each event, such as a related legal matter, an event category (as listed above), an author or owner of the event (human or computer), and a date and time of the event. At step 230, the event manager 122 stores the events created at step 220 in the eDiscovery data 126.

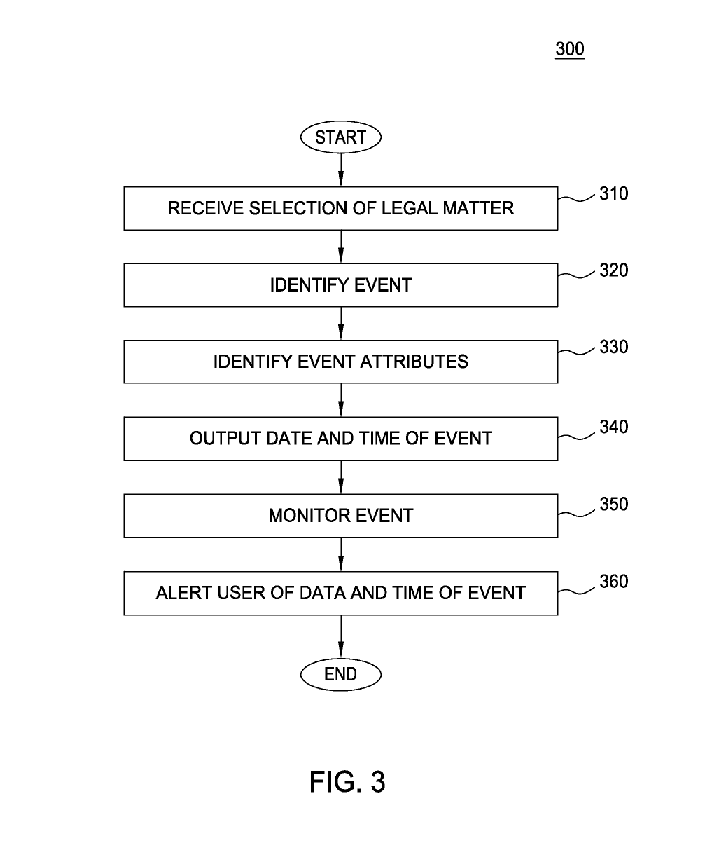

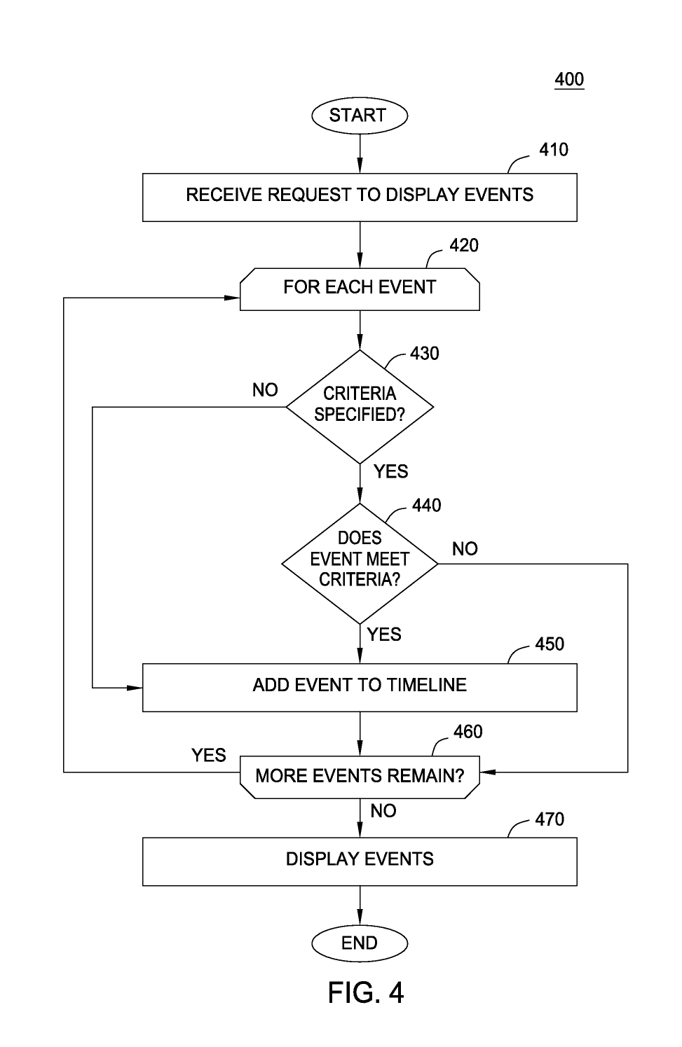

FIG. 3 is a flowchart illustrating a method 300 for using past and scheduled events to reduce the cost of mistakes in an electronic discovery process management system, according to one embodiment described herein. In some embodiments, the event manager 122 performs the steps of the method 300. The method 300 is an exemplary embodiment of the disclosure, as the disclosure contemplates additional functionality described with reference to FIGS. 4, 5 and 6. At step 310, the event manager receives a selection of a legal matter from the eDiscovery application 120. In some embodiments, information related to the legal matter is retrieved from the eDiscovery data 126. The selected legal matter may be passed as a variable by the eDiscovery application 120, the event manager 122, or selected by a user. At step 320, the event manager 122 identifies an event related to the legal matter. The event may be retrieved from entries associated with the legal matter in the eDiscovery data 126. At step 330, the event manager 122 identifies attributes of the identified event. In some embodiments, an event has the attributes of a related legal matter, an event category (as listed above), an author or owner of the event (human or computer), and a date and time of the event. In some embodiments, the attributes of the event are retrieved from the eDiscovery data 126. In other embodiments, the event manager 122 defines the attributes of an event. At step 340, the event manager 122 outputs the event and its attributes to a user for display. In some embodiments, the event and the attributes are output in the eDiscovery application 120. At step 350, the event manager 122 monitors the event in order to alert a user to an upcoming deadline. In some embodiments, the event manager 122 maintains a list of scheduled events and displays those events falling within a specified amount of time. In other embodiments, the event manager 122 may periodically check all events to determine whether the event date and time falls within a specified amount of time. At step 360, the event manager 122, upon determining that an event deadline is approaching, alerts a user of the event and its deadline. The event manager 122 may notify the user by any appropriate method, including but not limited to, highlighting events on a calendar, highlighting events on a list of events, email alerts, popup alert, and sound alerts.

FIG. 4 is a flowchart illustrating a method 400 for generating a list of events in an electronic discovery process management system, according to one embodiment described herein. In some embodiments, the event manager 122 performs the steps of method 400. At step 410, the event manager 122 receives a request to display a list of events. In some embodiments, a user (or the event manager 122) may specify certain criteria to be used in generating the list, which may be received along with the request by the event manager 122 at step 410. For example, a user may specify that the list display events related to three specific matters, or only display events created by a particular user. At step 420, the event manager 122 begins executing a loop which includes steps 430-460 for generating a list of events. In some embodiments, the loop executes at step 420 for all events related to all matters in the eDiscovery application 120. At step 430, the event manager 122 determines whether criteria have been specified to limit the events displayed. If criteria have not been specified, the event manager 122 proceeds to step 450. If criteria have been specified, the event manager 122 proceeds to step 440. At step 440, the event manager 122 determines whether the event meets the specified criteria. For example, the event manager 122 may determine whether the event has been created by a specified author, or is related to a specified legal matter. If the event meets the criteria, the event manager 122 proceeds to step 450. Otherwise, the event manager 122 proceeds to step 460. At step 450, the event manager 122 adds the event to the list. Listed events will be ordered sequentially by date, and the event manager 122 will sort the event based on its date and time attributes. One of ordinary skill in the art will recognize that the events may be sorted based on any sorting criteria. At step 460, the event manager 122 determines whether any events remain to be examined for inclusion. If more events remain, the event manager 122 returns to step 420. Otherwise, the event manager 122 moves to step 470, where the generated list is displayed.

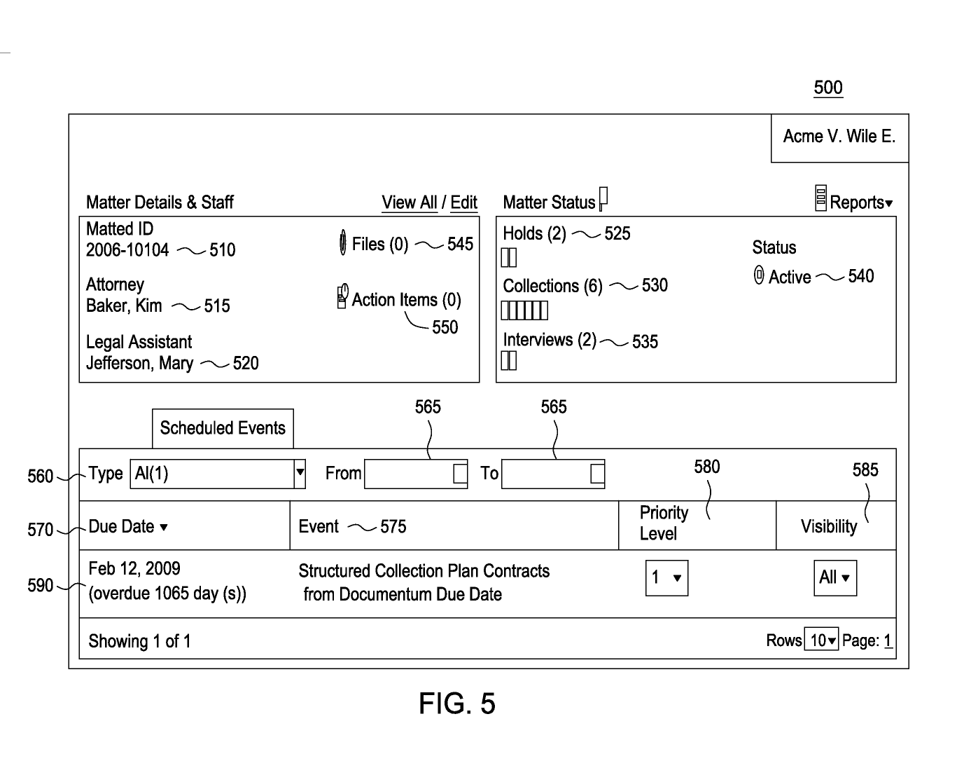

FIG. 5 illustrates an exemplary GUI screen 500 displaying scheduled events related to a matter in an electronic discovery process management system, according to one embodiment described herein. In some embodiments, the event manager 122 generates the GUI screen 500. In some other embodiments, the eDiscovery application 120 generates the GUI screen 500. As shown, the GUI screen 500 displays a plurality of details related to a legal matter, including a matter ID number 510 (specific to the eDiscovery application 120), a responsible attorney 515 and legal assistant 520, a number of holds 525 in place, a number of collections in place 530, a number of interviews 535, and the status of the matter 540. Element 545 indicates whether files have been attached to the matter. Element 550 indicates whether the matter has any pending action items. With respect to scheduled events, the element 560 provides an option to filter events, and element 565 allows a user to specify a date range within which event dates must occur. In some embodiments, element 555 will display past events in addition to scheduled events. Element 570 indicates a due date of the event, and element 575 provides a detailed description of the event. Element 580 indicates a priority level of the event, which may be changed by the user in some embodiments. In some embodiments, the priority level may be defined for all events of a particular type by the event manager 122. The priority level 580 may take any form sufficient to indicate multiple levels of priority, and although displayed as a dropdown list, may be configured to receive user input in any number of ways. Element 585 indicates a visibility level of the event, which may be set to a specific set of users, groups of users, all users, or any possible combination of these and other visibility requirements. The visibility 585 may take any form sufficient to indicate multiple types of visibility, and although displayed as a dropdown list, may be configured to receive user input in any number of ways. Element 590 indicates a particular event scheduled within the matter. In this example, element 590 is a structured collection plan related to contracts within the matter, which was due on Feb. 12, 2009, has a current priority level of 1, and is visible to all users. As shown, the event manager 122 also indicates that the matter is overdue by 1065 days. As shown, the event manager 122 is configured to receive user input to modify the priority level 580 and visibility 585 of the event. In some embodiments, the priority level 580 and visibility 585 of the event may be locked such that they may not be modified by a user.

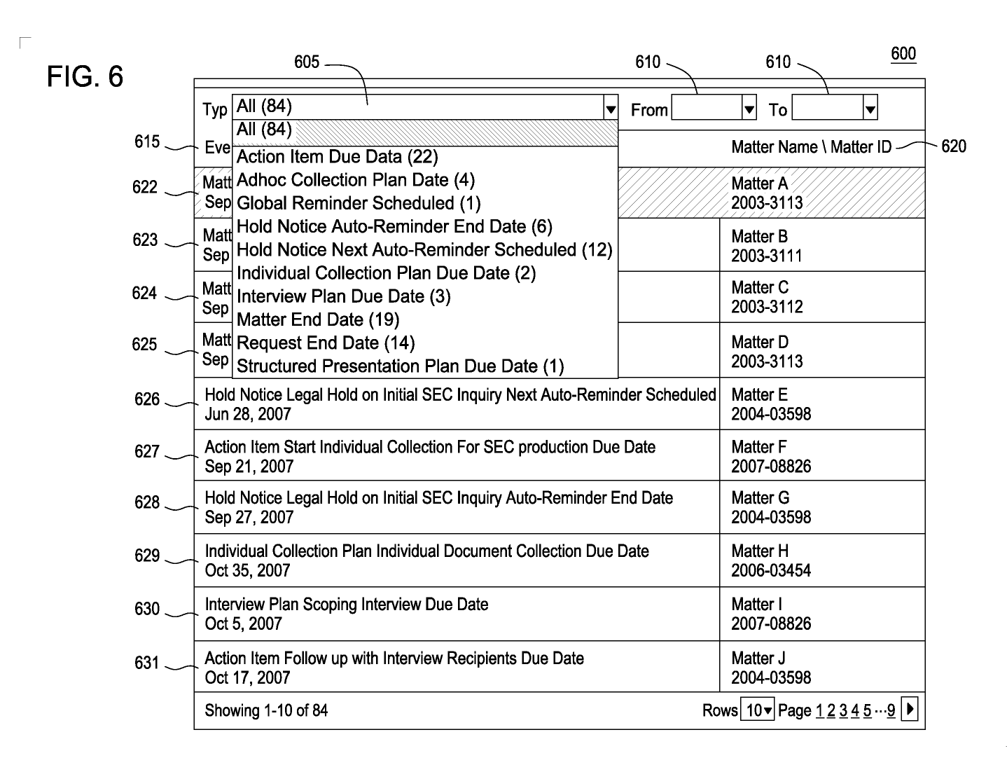

FIG. 6 illustrates an exemplary GUI screen 600 displaying a list of events within an electronic discovery process management system, according to one embodiment described herein. In some embodiments, the event manager 122 generates the GUI screen 600. In some other embodiments, the eDiscovery application 120 generates the GUI screen 600. As shown, the GUI screen 600 includes elements 605 and 610, which are configured to receive user input related to the display of events. Type element 605 is a dropdown list which allows a user to filter the list of displayed events based on numerous types, including, but not limited to, item due date, matter end date, request end date, and the next scheduled transmission date of auto-reminders. Element 610 is a date range input field which allows a user to specify a date range within which event dates must occur in order to be displayed in the GUI 600. Element 615 is a column indicating the event description, and element 620 is a column displaying the related matter's name and matter ID within the eDiscovery application 120. Elements 622-631 display specific events and related matter names and matter IDs. As shown, the events are sorted by date, but any suitable method for sorting the events may be implemented.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A computer-implemented method for using past and scheduled events to reduce the costs of mistakes in an electronic discovery process management system, comprising:
providing an electronic discovery process management system configured to manage a plurality of legal matters;
defining at least one scheduling rule associated with each legal matter;
scheduling, based on the at least one scheduling rule, at least one event associated with each matter in the electronic discovery process management system, each event comprising a set of attributes including a first attribute comprising a matter related to the event and a second attribute comprising a due date of the event; and
monitoring the at least one event to track the due date of the at least one event.

2. The computer-implemented method of claim 1, further comprising:
outputting the at least one event.

3. The computer-implemented method of claim 2, wherein the set of attributes of the at least one event further includes: (i) a category of the event, (ii) a creator of the event, (iii) a priority level of the event, and (iv) a visibility level of the event.

4. The computer-implemented method of claim 3, wherein at least one of the set of attributes has an attribute type specified by a user to be output.

5. The computer-implemented method of claim 4, wherein the at least one event is one of an activity, workflow, or event related to a legal matter.

6. The computer-implemented method of claim 5, further comprising:
notifying a user of the due date of the at least one event.

7. The computer-implemented method of claim 6, further comprising:
outputting a list of events in the electronic discovery process management system.

8. The computer-implemented method of claim 7, wherein the output events are filtered based on selection of at least one of: (i) one or more legal matters, (ii) one or more event categories, (iii) one or more event creators, (iv) a priority level, and (v) a date range.

9. A computer program product, comprising:
a computer-readable storage medium having computer-readable program code embodied therewith, the computer-readable program code comprising:
computer-readable program code configured provide an electronic discovery process management system configured to manage a plurality of legal matters;
computer-readable program code configured to define at least one scheduling rule associated with each legal matter;
computer-readable program code configured to schedule, based on the at least one scheduling rule, at least one event associated with each matter in the electronic discovery process management system, each event comprising a set of attributes including a first attribute comprising a matter related to the event and a second attribute comprising a due date of the event; and
computer-readable program code configured to monitor the at least one event to track the due date of the at least one event.

10. The computer program product of claim 9, wherein the set of attributes of the at least one event further includes: (i) a category of the event, (ii) a creator of the event, (iii) a priority level of the event, and (iv) a visibility level of the event.

11. The computer program product of claim 10, wherein at least one of the set of attributes has an attribute type specified by a user to be output.

12. The computer program product of claim 11, wherein the set of attributes of the at least one event further includes a priority level and a visibility level of the at least one event.

13. The computer program product of claim 12, wherein the at least one event is one of an activity, workflow, or event related to a legal matter.

14. The computer program product of claim 13, further comprising:
notifying a user of the due date of the at least one event.

15. The computer program product of claim 14, further comprising:
outputting a list of events in the electronic discovery process management system.

16. The computer program product of claim 15, wherein the output events are filtered based on selection of at least one of: (i) one or more legal matters, (ii) one or more event categories, (iii) one or more event creators, (iv) a priority level, and (v) a date range.

17. A system, comprising:
one or more computer processors;
a memory, communicably coupled to the one or more processors, containing a program, which, when executed by the one or more processors, performs an operation, the operation comprising:
providing an electronic discovery process management system configured to manage a plurality of legal matters;
defining at least one scheduling rule associated with each legal matter;
scheduling, based on the at least one scheduling rule, at least one event associated with each matter in the electronic discovery process management system, each event comprising a set of attributes including a first attribute comprising a matter related to the event and a second attribute comprising a due date of the event; and
monitoring the at least one event to track the due date of the at least one event.

18. The system of claim 17, the operation further comprising:
outputting the at least one event.

19. The system of claim 18, wherein the set of attributes of the at least one event further includes: (i) a category of the event, (ii) a creator of the event, (iii) a priority level of the event, and (iv) a visibility level of the event.

20. The system of claim 19, wherein at least one of the set of attributes has an attribute type specified by a user to be output.

21. The system of claim 20, wherein the at least one event is one of an activity, workflow, or event related to a legal matter.

22. The system of claim 21, the operation further comprising:
notifying a user of the due date of the at least one event.

23. The system of claim 22, the operation further comprising:
outputting a list of events in the electronic discovery process management system.

24. The system of claim 23, wherein the output events are filtered based on selection of at least one of: (i) one or more legal matters, (ii) one or more event categories, (iii) one or more event creators, (iv) a priority level, and (v) a date range.
